(19) United States
(12) Patent Application Publication
(10) Pub. No.: US 2025/0295132 A1
(43) Pub. Date: Sep. 25, 2025

(54) PIPING TOOL

(71) Applicant: EPOCH COMPANY, LTD., Tokyo (JP)

(72) Inventor: Ryo SAKAI, Tokyo (JP)

(73) Assignee: EPOCH COMPANY, LTD., Tokyo (JP)

(21) Appl. No.: 19/089,259

(22) Filed: Mar. 25, 2025

(30) Foreign Application Priority Data
Mar. 25, 2024 (JP) 2024-047608

(51) Int. Cl. A23G 3/28

(52) U.S. Cl. CPC A23G 3/28

(57) ABSTRACT

A piping tool includes: a container connecting member including a plurality of supply ports to which a plurality of containers are connectable in a first direction, respectively, each of the plurality of containers configured to contain a creamy substance; and a discharge member configured to merge a plurality of flow paths configured to allow creamy substances from the plurality of containers connected to the plurality of supply ports to pass therethrough, and discharge a merged creamy substance. Each of the plurality of flow paths is configured to directly suppresses leakage of the creamy substance by bringing an end surface of the container connecting member or an end surface of a corresponding one of the plurality of containers into surface-to-surface contact with a bottom surface of the discharge member in the first direction.

### CROSS-REFERENCE TO RELATED APPLICATIONS

This application is based on and claims priority under 35 USC 119 from Japanese Patent Application No. 2024-047608 filed on Mar. 25, 2025, the contents of which are incorporated herein by reference.

### TECHNICAL FIELD

The present disclosure relates to a piping tool for piping a creamy substance.

### BACKGROUND ART

There is a toy that creates an imitated food such as a cake by using a plurality of tubes filled with creamy resin. For example, JP2022-072926A has proposed a piping tool that includes four supply ports to which containers containing creamy substances are connectable, a merging portion that merges flow paths from supply ports, and a piping tip that discharges a creamy substance merged by the merging portion to the outside. This piping tool makes it possible to create a cream molded product with a wide range of variations.

### SUMMARY OF INVENTION

In the piping tool disclosed in JP2022-072926A, the number of parts is large and a sealing structure is complicated. Consequently, it is cumbersome for users such as children to prepare for use or clean it.

An object of the present disclosure is to provide a piping tool for a creamy substance which is easy to handle.

The present disclosure provides a piping tool including: a container connecting member including a plurality of supply ports to which a plurality of containers are connectable in a first direction, respectively, each of the plurality of containers configured to contain a creamy substance; and a discharge member configured to merge a plurality of flow paths configured to allow creamy substances from the plurality of containers connected to the plurality of supply ports to pass therethrough, and discharge a merged creamy substance, in which each of the plurality of flow paths is configured to directly suppresses leakage of the creamy substance by bringing an end surface of the container connecting member or an end surface of a corresponding one of the plurality of containers into surface-to-surface contact with a bottom surface of the discharge member in the first direction.

According to the present disclosure, it is possible to provide a piping tool for a creamy substance which is easy to handle.

### BRIEF DESCRIPTION OF DRAWINGS

The present disclosure will be described in detail based on the following without being limited thereto, wherein:

FIG. 1 is an overall view of a piping tool;

FIG. 2 is a perspective plan view of a container connecting member and a discharge member of the piping tool;

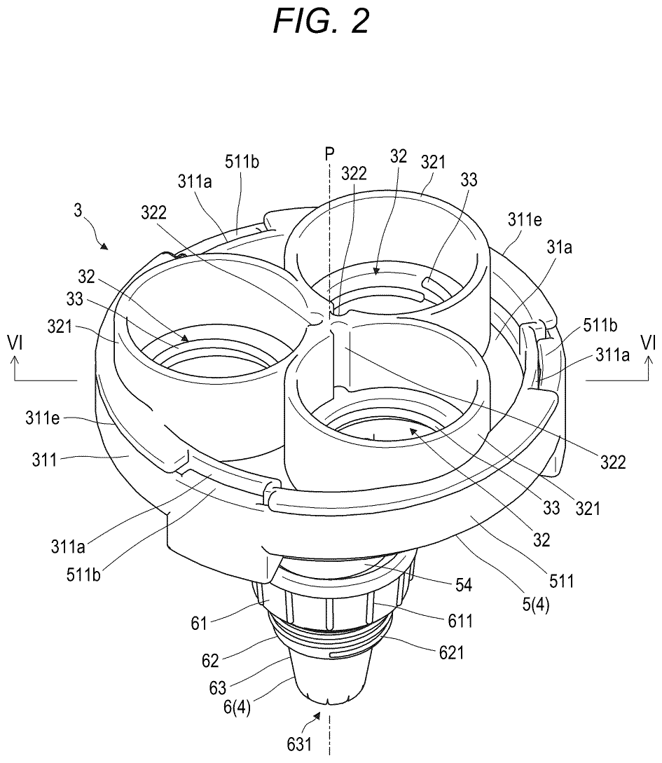

FIG. 3 is an exploded perspective plan view of the container connecting member and the discharge member;

FIG. 4 is an exploded perspective bottom view of the container connecting member and the discharge member;

FIG. 5 is a plan view of the container connecting member and the discharge member;

FIG. 6 is a sectional view of the container connecting member and the discharge member, taken along the line VI-VI of FIG. 2;

FIG. 7 is a sectional view of the container connecting member and the discharge member, taken along the sectional position VII-VII shown in FIG. 6;

FIG. 8 is a sectional view of the piping tool with a container connected thereto, corresponding to the VI-VI section; and

FIG. 9 is a sectional view of the piping tool in a state in which a creamy substance has flowed toward a piping tip, corresponding to the VI-VI section.

### DESCRIPTION OF EMBODIMENTS

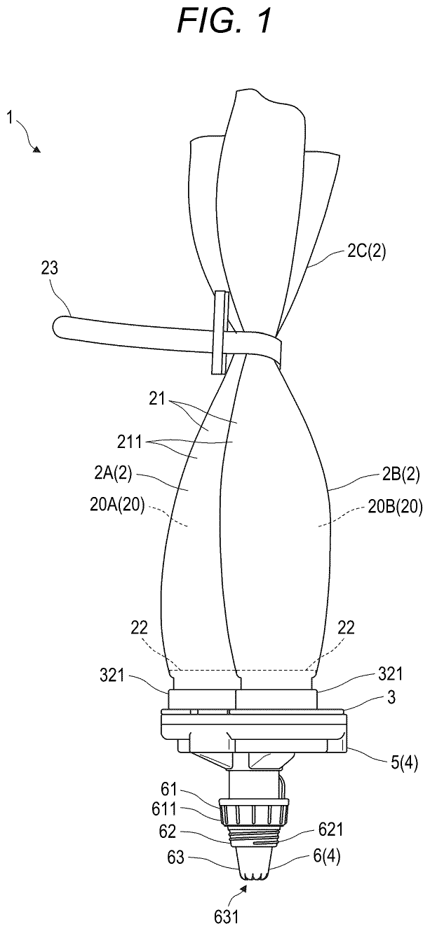

Hereinafter, an embodiment of the present disclosure will be described with reference to the drawings. FIG. 1 is an overall view of a piping tool 1. A user (e.g., a player such as a child) can pipe (extrude) a creamy substance 20 (20A to 20C) filled in each container 2 (2A to 2C) of the piping tool 1 from an opening 631 of a piping tip 6 at the tip by squeezing the creamy substance 20 to move from the rear (the upper part in FIG. 1) to the front (the lower part in FIG. 1) of the container 2. The piped creamy substance 20 can be used to create a decoration toy that imitates a western-style confectionery or the like decorated with fresh cream by being plated on a surface to be formed of a pedestal (object to be decorated) or the like (not shown).

The present embodiment describes an example in which cream resin is used as the creamy substance 20, and the piping tool 1 is applied as a decoration forming toy, mainly for play. Meanwhile, the piping tool 1 of the present embodiment may use a creamy substance such as whipped cream that is generally used for food, instead of the cream resin. In this case, the piping tool 1 can be used for plating food such as a sponge cake, instead of decoration toys.

The piping tool 1 includes a container connecting member 3 having a plurality of supply ports 32 (first supply port) to which the containers 2 containing the creamy substance 20 can be connected, and a discharge member 4 that merges flow paths L from each supply port 32 and discharges the merged creamy substance 20.

A bag body 21 containing the creamy substance 20 is provided in the majority of the rear part of the container 2. The bag body 21 is formed by stacking two flexible sheet members 211 made of polyvinyl chloride resin or the like and bonding them together by thermocompression or the like. The rear end portion of the bag body 21 is closed by bonding two stacked sheet members 211 by thermocompression or the like (details are not shown).

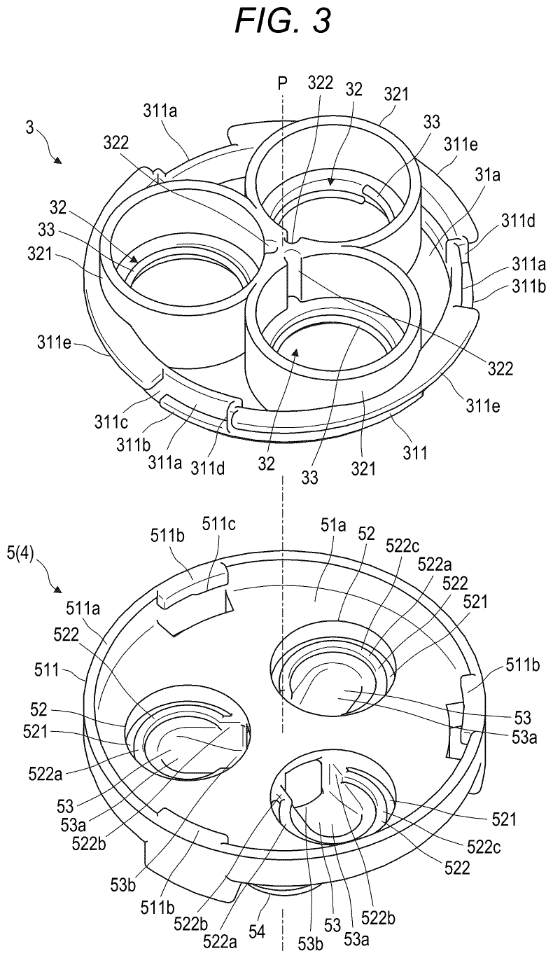

A plurality of containers 2 are connected to each supply port 32 (see FIG. 3 or the like) of the container connecting member 3. The piping tool 1 of the present embodiment uses three containers 2A to 2C, each of which contains a different type of creamy substances 20A to 20C (see FIG. 1) in the bag body 21. The creamy substance 20 filled in the bag body 21 imitates whipped cream and may contain, for example, synthetic adhesive, acrylic resin, cellulose, stabilizer, preservative, and the like. Therefore, the creamy substance 20 dries and solidifies when exposed to air. The creamy substances 20A to 20C of the present embodiment are each colored with a different color by adding a coloring agent. The creamy substance 20 may be formed to be transparent or translucent.

Further, the bag bodies 21 of the containers 2A to 2C are bounded together by a removable binding band 23 (see FIG. 1). By shifting the binding position toward the front as the amount of the creamy substances 20A to 20C decreases, the backward flow (backflow) of the creamy substances 20A to 20C can be reduced when using the piping tool 1.

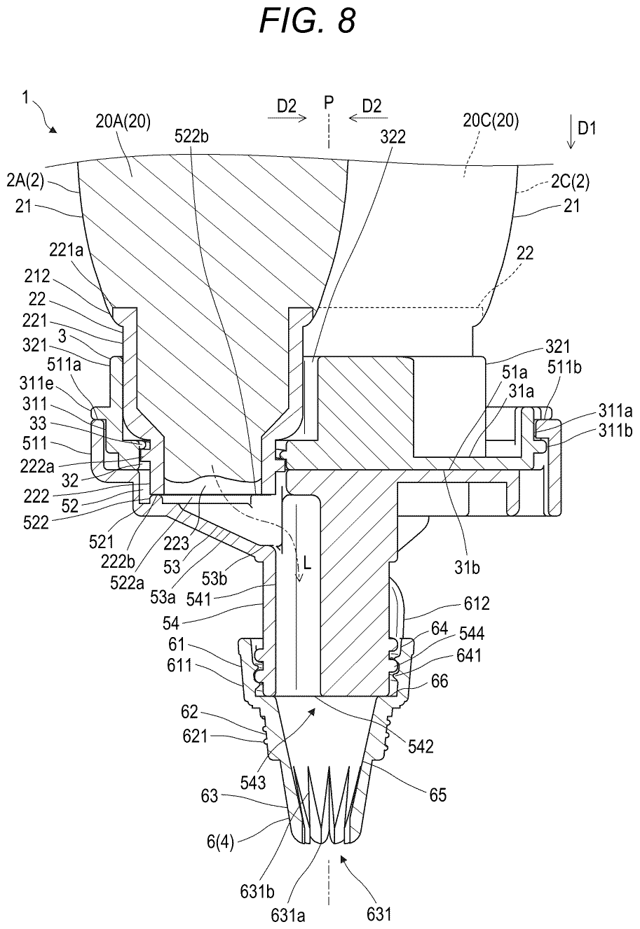

A connecting part 22 is formed in a substantially cylindrical shape as a whole (see also FIGS. 1 and 8). As shown in the sectional view of FIG. 8, a flange portion 221a is formed circumferentially at a rear end edge of a rear stage portion 221 of the connecting part 22. An opening 212 provided at the front end of the bag body 21 is connected to the connecting part 22. In the vicinity of this opening 212, the inner edge of the opening 212 is bonded to the rear stage portion 221 of the connecting part 22 so as to be in close contact therewith.

The inner edge of the opening 212 and the outer peripheral edge of the flange portion 221a of the rear stage portion 221 are closely connected, preventing the creamy substance 20 from leaking through a gap between the outer peripheral side surface of the rear stage portion 221 and the opening 212. Further, a male screw portion 222a is formed on the outer peripheral side surface of the front stage portion 222 of the connecting part 22. At the front end of the front stage portion 222, a discharge port 223 is formed, which is a circular opening that allows the creamy substance 20 to flow toward a tip connecting member 5.

The container connecting member 3 is connected to the discharge member 4, which merges the creamy substance 20 supplied from the supply port 32 to which the container 2 (see FIG. 8) is connected at a merging portion 543 disposed at a front side, and causes the creamy substance 20 to flow toward the piping tip 6. The discharge member 4 includes the tip connecting member 5 and the piping tip 6. The tip connecting member 5 is connected to the container 2 via the container connecting member 3 on one side and is also connected to the piping tip 6 on the other side.

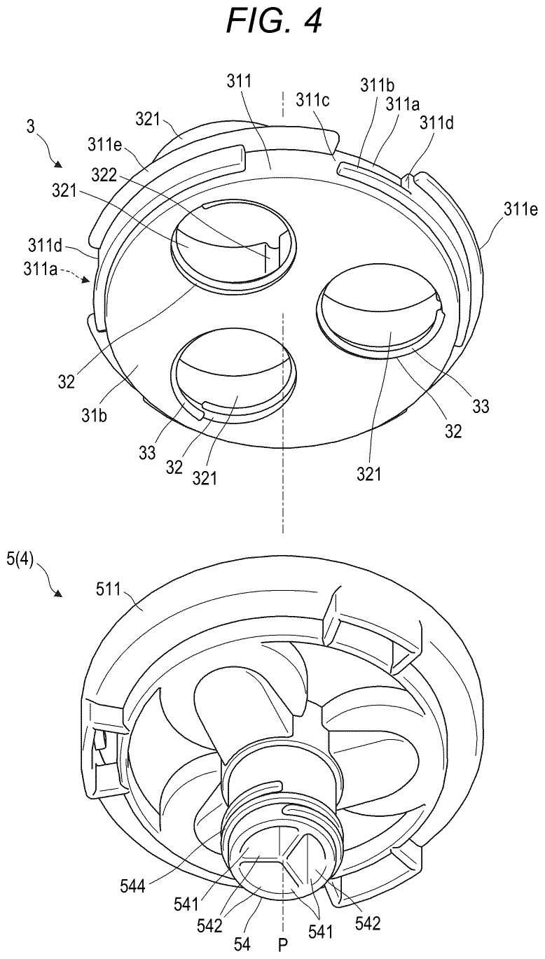

The tip connecting member 5 will be described below. As shown in FIGS. 3 and 4, the tip connecting member 5 is formed in a circular thick plate shape. The tip connecting member 5 has an outer peripheral portion 511 standing upward in an annular shape from its outer peripheral edge. An annular contact portion 511a is provided on the rear end edge of the outer peripheral portion 511. A plurality of engagement protrusions 511b are provided at intervals around an axis P on the inner edge of the rear end of the outer peripheral portion 511. The engagement protrusions 511b and a rear bottom surface 51a of the tip connecting member 5 (the discharge member 4) are spaced apart from each other.

The engagement protrusions 511b are provided to protrude inward from the outer peripheral portion 511. Further, the engagement protrusion 511b are provided at three locations at approximately equal intervals (at approximately equal angles around the axis P) in a circumferential direction around the axis P. The engagement protrusion 511b has a stepped portion 511c that protrudes on the surface facing the bottom surface 51a. On the engagement protrusion 511b, the stepped portion 511c is provided on the clockwise side of the axis P when viewed in a connecting direction D1 (an example of a first direction).

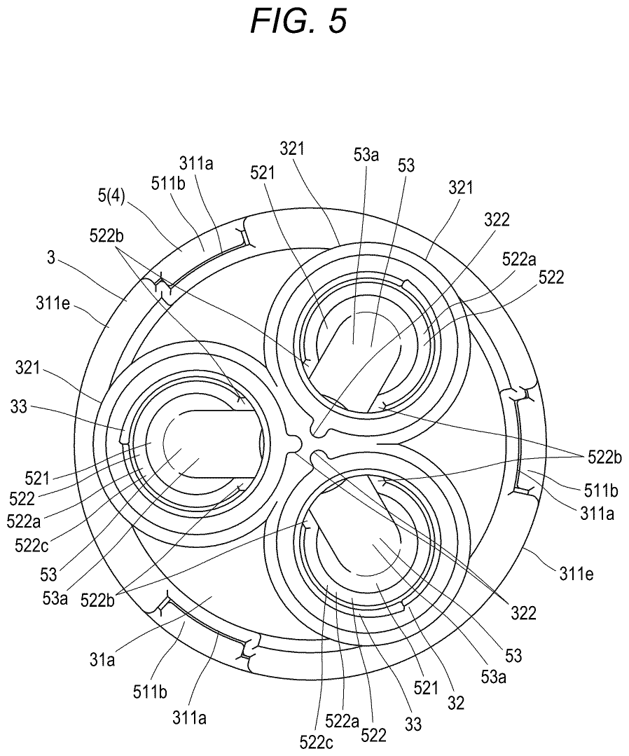

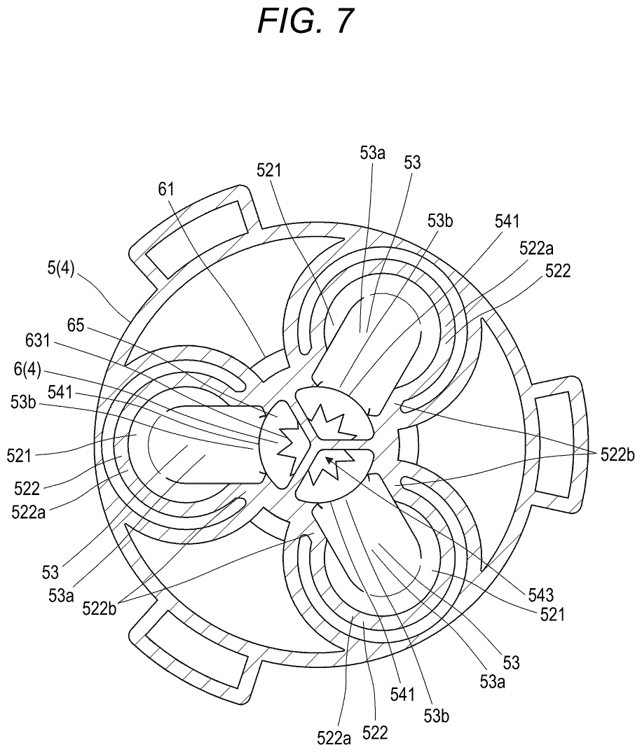

The tip connecting member 5 has circularly recessed supply ports 52 on the bottom surface 51a. The supply ports 52 (second supply port) are provided at three locations at approximately equal intervals (at approximately equal angles) in the circumferential direction around the axis P. The supply port 52 is a substantially circular recess portion. A bottom surface 521 of the supply port 52 is formed in a substantially flat surface shape. The bottom surface 521 is formed as a part of the bottom surface 51a. A protruding portion 522 that protrudes rearward (upward in FIG. 3) of the piping tool 1 is formed on the bottom surface 521. The protruding portion 522 is a rib formed in a substantially 22 shape in a plan view (see FIGS. 5 and 7). An end surface 522c of the protruding portion 522 is located at the front side from the bottom surface 51a (i.e., closer to the piping tip 6) and is formed in a flat shape. The protruding portion 522 has a C-shaped annular portion 522a, and a straight portion 522b connected to an inner wall of the supply port 52 in a straight line from positions corresponding to both ends of the C-shape of the C-shaped annular portion 522a.

The tip connecting member 5 has inclined guide portions 53 on the bottom surface 521 inside the protruding portion 522. The inclined guide portions 53 guide the respective flow paths L continuing from a plurality of containers 2 connected to supply ports 32 of the container connecting member 3 in a mutual approaching directions D2 (in the directions toward the axis P, an example of second directions). The inclined guide portion 53 has an inclined surface 53a inclined in the approaching direction D2, and a discharging surface 53b that is a flat surface perpendicular to the connecting direction D1 of the container 2. The inclined surface 53a and the discharging surface 53b are continuous surfaces. Further, the inclined surface 53a and the discharging surface 53b are provided to extend in the approaching direction D2 with approximately the same width. In addition, the inclined surface 53a is formed with a shallow gradient (for example, a gradient of 45 degrees or less) with respect to the approaching direction D2.

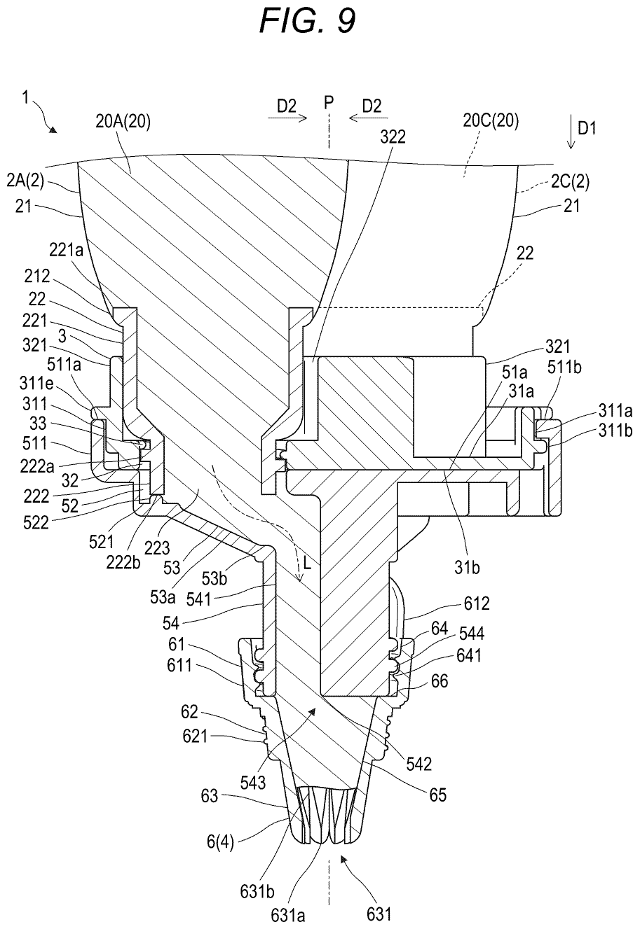

Further, as shown in FIGS. 8 and 9, the majority of the inclined guide portion 53 is positioned on the extension of the discharge port 223 of the container 2. In the present embodiment, the inclined guide portion 53 is disposed at a position where the majority of the inclined surface 53a overlaps with the extension of the discharge port 223 (in the connecting direction D1 of the container 2) in a plan view.

The tip connecting member 5 has a conduit portion 54. The conduit portion 54 is formed in a hollow cylindrical shape that has a plurality of discharge passages 541 divided into three sections around the axis P by the inner wall (see FIG. 7). Therefore, the cross-section of each discharge passage 541 is formed in a sector shape with an obtuse interior angle (approximately 120 degrees in the present embodiment) (see FIG. 7). The flow path L of the discharge passage 541 is connected to the discharge side of the inclined guide portion 53. Further, the discharge passage 541 is formed in a direction along the axis P, which is the connecting direction D1 of the container 2.

The discharge passage 541 is the flow path L of the creamy substance 20 guided by the inclined guide portion 53. In the present embodiment, the discharge passages 541 from the containers 2 connected to the supply ports 52 provided at three locations (see also FIG. 7) are guided by the inclined guide portions 53 and arranged side by side in approximately the same direction in the conduit portion 54.

Openings 542 on the front end side of the respective discharge passages 541 have opening surfaces on the same plane, respectively (see also FIG. 4). Therefore, the merging portion 543 where the respective discharge passages 541 forming the flow paths L are merged are formed at the front end of the conduit portion 54.

A male screw portion 544 that can be screwed with a female screw portion 641 of the piping tip 6 is provided on the outer peripheral side surface of the conduit portion 54 on the opening 542 side.

Next, the container connecting member 3 will be described. The container connecting member 3 is formed in a substantially circular plate shape whose diameter is smaller than that of the outer peripheral portion 511 of the tip connecting member 5. The container connecting member 3 has an outer peripheral portion 311 that stands upward in an annular shape from its outer peripheral edge. The outer peripheral portion 311 is provided with an engaging recess portion 311a recessed toward the axis P. On the engaging recess portion 311a, a protruding portion 311b extending in the circumferential direction with respect to the axis P is provided on the front side of the piping tool 1 (the lower side in FIG. 3).

Flange portions 311e are formed on the outer surface of the outer peripheral portion 311. The flange portions 311e are formed intermittently. The protruding portion 311b and the flange portion 311e are spaced apart in the direction of the axis P. An opening portion 311c is provided on one side in the circumferential direction, and a closed restriction portion 311d is provided on the other side in the circumferential direction.

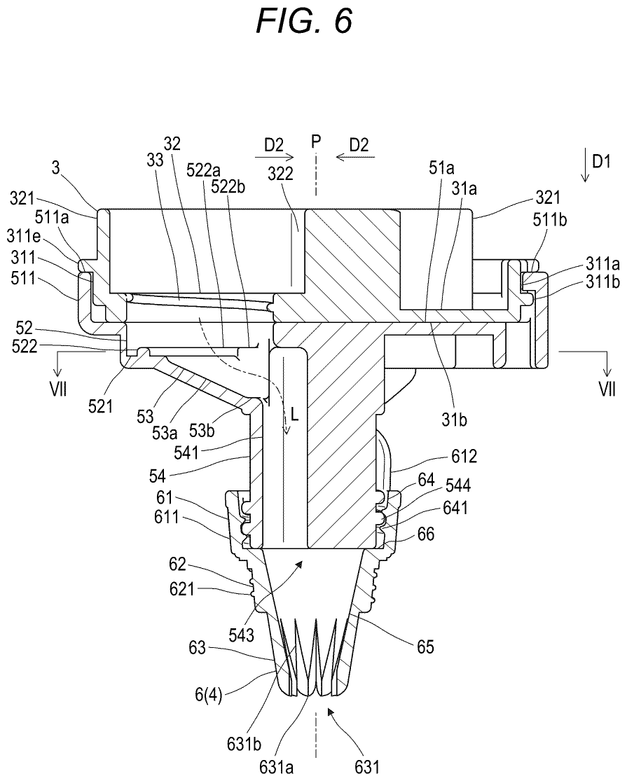

The container connecting member 3 can be placed on the tip connecting member 5 with the flange portions 311e in contact with the contact portion 511a (see also FIG. 6). Further, when the engagement protrusion 511b is inserted into the engaging recess portion 311a from the opening portion 311c side, and the engagement protrusion 511b is engaged with the engaging recess portion 311a, the container connecting member 3 and the tip connecting member 5 are connected. At this time, as the stepped portion 511c of the engagement protrusion 511b comes into contact with the protruding portion 311b, the container connecting member 3 is pressed toward the tip connecting member 5. On the other hand, since a flat end surface 31b of the container connecting member 3 comes into contact with the bottom surface 51a of the tip connecting member 5 (the discharge member 4), the container connecting member 3 is substantially clamped by the engagement protrusion 511b and the bottom surface 51a, and is fixed to the tip connecting member 5.

The container connecting member 3 has a plurality of (three in this embodiment) circular supply ports 32 provided around the axis P. The inner diameter of the supply port 32 is set to be approximately the same as the inner diameter of the supply port 52 in the tip connecting member 5 (see FIG. 6). A female screw portion 33 is formed on the inner surface of the supply port 32. The container 2 is fixed to the container connecting member 3 by screwing the male screw portion 222a of the connecting part 22 with the female screw portion 33 of the supply port 32.

Further, a cylindrical wall portion 321 stands rearward (upward in FIG. 3) from the rear surface portion 31a around the outer periphery of the supply port 32. The inner diameter of the cylindrical wall portion 321 is set to be larger than the opening diameter of the supply port 32.

The cylindrical wall portion 321 has a groove portion 322 extending in a direction along the axis P on its inner wall on the axis P side. As shown in FIG. 5, the groove portion 322 is formed in a concave arc shape in a plan view.

As shown in FIG. 6, the piping tip 6 has a rear stage portion 61 having a large outer diameter, a middle stage portion 62 having a smaller outer diameter than the rear stage portion 61, and a front stage portion 63 having a smaller outer diameter than the middle stage portion 62. The entire piping tip 6 is formed in a substantially conical cylindrical shape. On the outer peripheral side surface of the rear stage portion 61, a plurality of rib portions 611 are formed in a front and rear direction (an upper and lower direction in FIG. 1 or FIG. 6). An indication plate 612 is provided from a part of a side surface of the rear stage portion 61. The indication plate 612 is spaced apart from the axis P and extended rearward. The indication plate 612 is formed in a flat plate shape (details are not shown). The shape type of the opening 631 of the piping tip 6 can be displayed on the outer surface of the indication plate 612 by using letters, figures, or a combination thereof. The shape type may include the shape or size of the opening 631.

Further, a male screw portion 621 is provided on the outer peripheral side surface of the middle stage portion 62. A cap that can be screwed with the male screw portion 621 can be removably attached to the piping tip 6. In this way, when the piping tool 1 is not in use, the piping tip 6 can be protected from external damage, and the creamy substance 20 in the piping tool 1 can be prevented from drying out.

The outer diameter of the front stage portion 63 is gradually reduced toward the front. The opening 631 is formed at the front end of the front stage portion 63. The opening 631 may have, for example, an opening shape commonly used in a piping tool for whipped cream. In the present embodiment, a star-shape 8-cut type is used. Therefore, the opening 631 have eight sharpened plates 631a arranged along an annular shape such that their acute apexes facing the center of the opening 631 in a bottom view seen from below (details are not shown). A notch 631b is formed between the sharpened plates 631a.

In addition, as shown primarily in FIG. 6, the piping tip 6 has a rear inner wall portion 64 having a large inner diameter, and a front inner wall portion 65 having a smaller inner diameter than the rear inner wall portion 64. The rear inner wall portion 64 is provided with the female screw portion 641 that is screwed with the male screw portion 544 of the conduit portion 54. The inner diameter of the front inner wall portion 65 is gradually reduced in a cone shape toward the opening 631.

At a boundary between the rear inner wall portion 64 and the front inner wall portion 65, a rear contact portion 66 having an annular flat surface oriented rearward is formed to form a step between the rear inner wall portion 64 and the front inner wall portion 65. The front end of the conduit portion 54 comes into contact with the rear contact portion 66, thereby restricting the screwing depth (in other words, the screwing position) of the conduit portion 54 into the piping tip 6.

Next, the flow path L of the creamy substance 20 will be described below. FIG. 8 is a sectional view of the piping tool 1 with the container 2 connected thereto, corresponding to the VI-VI section. Further, FIG. 9 is a sectional view of the piping tool 1 in a state in which the creamy substance 20 has flowed toward the piping tip 6, corresponding to the VI-VI section.

The piping tool 1 in FIG. 8 shows a state in which the container 2, the container connecting member 3, and the discharge member 4 (the tip connecting member 5, the piping tip 6) are connected, and the container 2 is filled with the creamy substance 20. When a user moves the creamy substances 20A to 20C contained in the containers 2A to 2C to be piped toward the piping tip 6, each of the creamy substances 20A to 20C moves toward the front container connecting member 3 and the discharge member 4 (see FIG. 8). The flow path L is formed by bringing an end surface 222b of the container 2 into surface-to-surface contact with the bottom surface 51a of the tip connecting member 5 (the discharge member 4) in the connecting direction D1 of the container 2.

In the configuration of the present embodiment, the annular end surface 222b around the discharge port 223 of the container 2 comes into surface-to-surface contact with the top surface of the Ω-shaped protruding portion 522 formed on the bottom surface 51a of the tip connecting member 5 (the discharge member 4). Therefore, the creamy substance 20 flowing from the container 2 into the supply port 52 moves along the inner wall of the C-shaped annular portion 522a of the protruding portion 522, and then, moves toward the discharge passage 541 along the inner wall of the straight portion 522b. With this configuration, the leakage of the creamy substance 20 is directly suppressed.

Further, the flow path L is formed by bringing the end surface 222b of the container 2 into surface-to-surface contact with the bottom surface 51a of the tip connecting member 5 (the discharge member 4) and bringing the end surface 31b of the container connecting member 3 into surface-to-surface contact with the bottom surface 51a of the tip connecting member 5 (the discharge member 4) in the connecting direction D1 of the container 2. In this way, the flow path L can prevent the leakage of the creamy substance 20 due to its double sealing structure.

Further, in the present embodiment, a part of the discharge passage 541 is disposed to be located within the opening of the supply port 52 (second supply port) connected to the container 2 when viewed from the rear to the front in the connecting direction D1. Therefore, the creamy substance 20 can be easily moved from the supply port 52 to the discharge passage 541 with less force (low resistance). Furthermore, in the present embodiment, the inclined guide portion 53 is provided in the flow path L, so that the movement of the creamy substance 20 from the supply port 52 to the discharge passage 541 can be made easier with less force (low resistance).

The creamy substances 20 that have passed through the respective discharge passages 541 are joined at the merging portion 543 provided at the front end of the conduit portion 54 and move toward the opening 631 of the piping tip 6 while being integrated with a substantially uniform cross-sectional ratio (see FIG. 9).

Thereafter, the integrated creamy substance 20 is extruded onto a surface to be formed (or decorative surface) (not shown). After an appropriate amount of creamy substance 20 has been extruded, a user moves the piping tool 1 away from the surface to be formed. When the piping tool 1 is pulled up, the creamy substance 20 adhered to the surface to be formed in the vicinity of the axis P is pulled upward by the creamy substance 20 adhered to the piping tip 6 moving away from the surface to be formed, thereby forming an apex. In this way, a three-dimensional cream decoration with a horn in the center is created.

When the creamy substances 20A to 20C filled in the three containers 2A to 2C are of different colors, the cream decoration is sectioned radially as viewed from above and is colored in three colors. Therefore, it is easy to create a cream decoration with a wide variety of color schemes in multiple colors.

In addition, when the creamy substances 20A to 20C filled in the three containers 2A to 2C have other forms (for example, transparency, decoration such as lame or chip parts, and the like) different from each other, the cream decoration is sectioned radially as viewed from above and include three different forms. Therefore, it is possible to create a wide variety of cream decorations that integrally include a plurality of forms of creamy substances 20A to 20C.

Then, the cream decoration is dried for a predetermined period of time until it hardens to a hardness suitable for storage or use as a decoration.

According to the embodiments of the present disclosure as described above, a piping tool having the following configurations can be provided.

In a first aspect, there is provided a piping tool including: a container connecting member including a plurality of supply ports to which a plurality of containers are connectable in a first direction, respectively, each of the plurality of containers configured to contain a creamy substance; and a discharge member configured to merge a plurality of flow paths configured to allow creamy substances from the plurality of containers connected to the plurality of supply ports to pass therethrough, and discharge a merged creamy substance, in which each of the plurality of flow paths is configured to directly suppresses leakage of the creamy substance by bringing an end surface of the container connecting member or an end surface of a corresponding one of the plurality of containers into surface-to-surface contact with a bottom surface of the discharge member in the first direction.

According to this aspect, the piping tool 1 can prevent unintentional leakage of the creamy substance 20 while simply constructing the sealing structure of the flow path L with a small number of parts. Further, since the piping tool 1 is simply constructed, the piping tool can be easily cleaned after use. Therefore, it is possible to construct the piping tool 1 for the creamy substance that is easy to handle.

In the piping tool according to a second aspect, the discharge member includes a tip connecting member, the tip connecting member being configured to be connected to the plurality of containers on one side of the tip connecting member in the first direction and configured to be connected to a piping tip on another side of the tip connecting member in the first direction.

According to this aspect, the flow path L can be formed in one direction form one side to the other side. Therefore, the creamy substance 20 can be moved with less force.

In the piping tool according to a third aspect, the container and the piping tip are connected via only two components consisting of the container connecting member and the tip connecting member to form the plurality of flow paths.

According to this aspect, the piping tool 1 is composed of a small number of parts, so that the number of parts to be cleaned after use can be reduced. Further, the piping tool 1 can be easily assembled and disassembled by a user (especially, child).

In the piping tool according to a fourth aspect, the tip connecting member includes a plurality of inclined guide portions configured to guide the plurality of flow paths in second directions, respectively, the second directions in which the plurality of flow paths approach each other, and the plurality of inclined guide portions are positioned on extensions of discharge ports of the plurality of containers in the first direction, respectively.

According to this aspect, the plurality of flow paths L of the creamy substance 20 are integrated via the inclined guide portion 53, so that the creamy substance 20 can be easily flowed toward the piping tip 6 with less force.

In the piping tool according to a fifth aspect, each of the plurality of inclined guide portions includes an inclined surface with a gradient of 45 degrees or less with respect to the second directions.

According to this aspect, the volume of the flow path L from the end surface 222b of the container 2 to the piping tip 6 can be suppressed while easily guiding the creamy substance 20 to the discharge passage 541 side. Therefore, the amount of creamy substance 20 remaining in the container connecting member 3 or the discharge member 4 after use can be reduced.

In the piping tool according to a sixth aspect, the tip connecting member includes a conduit portion in which as a plurality of discharge passages, the plurality of flow paths guided by the inclined guide portions are provided in parallel.

According to this aspect, the cross-sectional areas of the creamy substances 20A to 20C discharged from the different containers 2A to 2C and merged by the merging portion 543 can be made substantially uniform, and a creamy substance obtained by integrating a plurality of creamy substances 20A to 20C can be discharged from the piping tip 6 with a good appearance.

In the piping tool according to a seventh aspect, the tip connecting member includes a plurality of second supply ports configured to receive tip ends of the plurality of containers, respectively, and a part or a whole of each of the plurality of discharge passages is disposed within an opening of a corresponding one of the plurality of second supply ports in the first direction.

According to this aspect, the inside of the discharge passage 541 can be easily seen from the front side (the piping tip 6 side) or the rear side (the container 2 side) of the tip connecting member 5, and the insertion of a cleaning tool and the entry of a cleaning liquid (e.g., water) can be facilitated, making it easy to clean the piping tool 1. Further, since a part or the whole of the discharge passage 541 is disposed within an opening of a second supply port connected to the container 2 in the connecting direction D1, the flowing of the creamy substance 20 can be facilitated.

In the piping tool according to an eighth aspect, when the end surface of each of the plurality of containers comes into surface-to-surface contact with the bottom surface of the discharge member, an annular end surface around a discharge port of each of the plurality of containers comes into surface-to-surface contact with a top surface of a corresponding one of a plurality of protruding portions formed on the bottom surface of the discharge member, each of the plurality of protruding portions having an Ω shape when viewed from the first direction.

According to this aspect, the creamy substance 20 that flows from the container 2 into the supply port 52 moves inside the C-shaped annular portion 522a of the protruding portion 522, and then moves toward the discharge passage 541 along the inner wall of the straight portion 522b. Therefore, the creamy substance 20 can be easily flowed while preventing the leakage of the creamy substance 20.

In the piping tool according to a ninth aspect, the container and the piping tip are connected via only two components consisting of the container connecting member and the tip connecting member to form the plurality of flow paths, the tip connecting member includes a plurality of inclined guide portions configured to guide the plurality of flow paths in second directions, respectively, the second directions in which the plurality of flow paths approach each other, the plurality of inclined guide portions are positioned on extensions of discharge ports of the plurality of containers in the first direction, respectively, each of the plurality of inclined guide portions includes an inclined surface with a gradient of 45 degrees or less with respect to the second directions, the tip connecting member includes a conduit portion in which as a plurality of discharge passages, the plurality of flow paths guided by the inclined guide portions are provided in parallel, the tip connecting member includes a plurality of second supply ports configured to receive tip ends of the plurality of containers, respectively, a part or a whole of each of the plurality of discharge passages is disposed within an opening of a corresponding one of the plurality of second supply ports in the first direction, and when the end surface of each of the plurality of containers comes into surface-to-surface contact with the bottom surface of the discharge member, an annular end surface around a discharge port of each of the plurality of containers comes into surface-to-surface contact with a top surface of a corresponding one of a plurality of protruding portions formed on the bottom surface of the discharge member, each of the plurality of protruding portions having an Ω shape when viewed from the first direction.

According to this aspect, the flow path L can be formed in one direction form one side to the other side. Therefore, the creamy substance 20 can be moved smoothly. Further, since the plurality of flow paths L of the creamy substance 20 are integrated via the inclined guide portion 53, the creamy substance 20 can be easily flowed toward the piping tip 6 with less force. In addition, since the volume of the flow path L from the end surface 222b of the container 2 to the piping tip 6 can be suppressed while easily guiding the creamy substance 20 to the discharge passage 541 side, the amount of creamy substance 20 remaining in the container connecting member 3 or the discharge member 4 after use can be reduced. Additionally, the cross-sectional areas of the creamy substances 20A to 20C discharged from the different containers 2A to 2C and merged by the merging portion 543 can be made uniform, and a creamy substance obtained by integrating a plurality of creamy substances 20A to 20C can be discharged from the piping tip 6 with a good appearance.

In addition, the inside of the discharge passage 541 can be easily seen from the front side (the piping tip 6 side) or the rear side (the container 2 side) of the tip connecting member 5, and the insertion of a cleaning tool and the entry of a cleaning liquid (e.g., water) can be facilitated, making it easy to clean the piping tool 1. Further, since a part or the whole of the discharge passage 541 is disposed within an opening of a second supply port connected to the container 2 in the connecting direction D1, the flowing of the creamy substance 20 can be facilitated. In addition, the creamy substance 20 that flows from the container 2 into the supply port 52 moves inside the C-shaped annular portion 522a of the protruding portion 522, and then moves toward the discharge passage 541 along the inner wall of the straight portion 522b. Therefore, the creamy substance 20 can be easily flowed while preventing the leakage of the creamy substance 20.

This concludes the description of the embodiments of the present disclosure, but the aspects of the present disclosure are not limited to these embodiments. For example, although the present embodiment represents an example in which the flow path L is formed by bringing the end surface 222b of the container 2 into surface-to-surface contact with the bottom surface 51a of the tip connecting member 5 (the discharge member 4) in the connecting direction D1 of the container 2, the end surface 31b of the container connecting member 3 may be brought into surface-to-surface contact with the bottom surface 51a of the tip connecting member 5 (the discharge member 4) in the connecting direction D1 of the container 2. Also with this configuration, the leakage of the creamy substance 20 from the flow path L can be directly suppressed, making it possible to configure the piping tool 1 that has a simplified structure and is easy to handle.

Further, although the present embodiment has described a configuration in which a part of the discharge passage 541 is positioned in the opening of the supply port 52 (second supply port) in the connecting direction D1, the whole of the discharge passage 541 may be positioned in the opening of the supply port 52 (second supply port) in the connecting direction D1. In this way, the flow path L in the piping tool 1 is formed linearly in the connecting direction D1, making it even easier for a user to clean the piping tool 1.

What is claimed is:

1. A piping tool comprising:
a container connecting member comprising a plurality of supply ports to which a plurality of containers are connectable in a first direction, respectively, each of the plurality of containers configured to contain a creamy substance; and
a discharge member configured to merge a plurality of flow paths configured to allow creamy substances from the plurality of containers connected to the plurality of supply ports to pass therethrough, and discharge a merged creamy substance,
wherein each of the plurality of flow paths is configured to directly suppresses leakage of the creamy substance by bringing an end surface of the container connecting member or an end surface of a corresponding one of the plurality of containers into surface-to-surface contact with a bottom surface of the discharge member in the first direction.

2. The piping tool according to claim 1,
wherein the discharge member comprises a tip connecting member, the tip connecting member being configured to be connected to the plurality of containers on one side of the tip connecting member in the first direction and configured to be connected to a piping tip on another side of the tip connecting member in the first direction.

3. The piping tool according to claim 2,
wherein the container and the piping tip are connected via only two components consisting of the container connecting member and the tip connecting member to form the plurality of flow paths.

4. The piping tool according to claim 2,
wherein the tip connecting member comprises a plurality of inclined guide portions configured to guide the plurality of flow paths in second directions, respectively, the second directions in which the plurality of flow paths approach each other, and
wherein the plurality of inclined guide portions are positioned on extensions of discharge ports of the plurality of containers in the first direction, respectively.

5. The piping tool according to claim 4,
wherein each of the plurality of inclined guide portions comprises an inclined surface with a gradient of 45 degrees or less with respect to the second directions.

6. The piping tool according to claim 4,
wherein the tip connecting member comprises a conduit portion in which as a plurality of discharge passages, the plurality of flow paths guided by the inclined guide portions are provided in parallel.

7. The piping tool according to claim 6,
wherein the tip connecting member comprises a plurality of second supply ports configured to receive tip ends of the plurality of containers, respectively, and
wherein a part or a whole of each of the plurality of discharge passages is disposed within an opening of a corresponding one of the plurality of second supply ports in the first direction.

8. The piping tool according to claim 1,
wherein when the end surface of each of the plurality of containers comes into surface-to-surface contact with the bottom surface of the discharge member, an annular end surface around a discharge port of each of the plurality of containers comes into surface-to-surface contact with a top surface of a corresponding one of a plurality of protruding portions formed on the bottom surface of the discharge member, each of the plurality of protruding portions having an Ω shape when viewed from the first direction.

9. The piping tool according to claim 2,
wherein the container and the piping tip are connected via only two components consisting of the container connecting member and the tip connecting member to form the plurality of flow paths,
wherein the tip connecting member comprises a plurality of inclined guide portions configured to guide the plurality of flow paths in second directions, respectively, the second directions in which the plurality of flow paths approach each other,
wherein the plurality of inclined guide portions are positioned on extensions of discharge ports of the plurality of containers in the first direction, respectively,
wherein each of the plurality of inclined guide portions comprises an inclined surface with a gradient of 45 degrees or less with respect to the second directions,
wherein the tip connecting member comprises a conduit portion in which as a plurality of discharge passages, the plurality of flow paths guided by the inclined guide portions are provided in parallel,
wherein the tip connecting member comprises a plurality of second supply ports configured to receive tip ends of the plurality of containers, respectively,
wherein a part or a whole of each of the plurality of discharge passages is disposed within an opening of a corresponding one of the plurality of second supply ports in the first direction, and
wherein when the end surface of each of the plurality of containers comes into surface-to-surface contact with the bottom surface of the discharge member, an annular end surface around a discharge port of each of the plurality of containers comes into surface-to-surface contact with a top surface of a corresponding one of a plurality of protruding portions formed on the bottom surface of the discharge member, each of the plurality of protruding portions having an Ω shape when viewed from the first direction.
